(19) United States
(12) Patent Application Publication
(10) Pub. No.: US 2023/0159339 A1
(43) Pub. Date: May 25, 2023

(54) SILICON CARBIDE POWDER AND PRODUCTION METHOD THEREOF

(71) Applicant: FUJIMI INCORPORATED, Kiyosu-shi, Aichi (JP)

(72) Inventors: Naoki Ushida, Kiyosu-shi, Aichi (JP); Yuji Masuda, Kiyosu-shi, Aichi (JP); Mina Sato, Kiyosu-shi, Aichi (JP)

(73) Assignee: FUJIMI INCORPORATED, Kiyosu-shi, Aichi (JP)

(21) Appl. No.: 17/910,548

(22) PCT Filed: Dec. 11, 2020
(86) PCT No.: PCT/JP2020/046280

§ 371 Date: Sep. 9, 2022

(30) Foreign Application Priority Data
Mar. 11, 2020 (JP) 2020-41826

(51) Int. Cl. C01B 32/90; C09C 1/28; C09C 3/04

(52) U.S. Cl. CPC C01B 32/90; C09C 1/28; C09C 3/041; C01P 2004/62; C01P 2006/80

(57) ABSTRACT

There is provided a silicon carbide powder having a small mean particle diameter and a narrow particle diameter distribution width. A silicon carbide powder is a powder of silicon carbide (SiC) having an α-type crystal form and has a mean particle diameter of 300 nm or less. In the silicon carbide powder, a ratio D90/D10 between a particle diameter D10 and a particle diameter D90 is 4 or less, the particle diameter D10 being a particle diameter at which the cumulative particle volume from the small particle diameter side in a volume-based cumulative particle diameter distribution reaches 10% of the total particle volume and the particle diameter D90 being a particle diameter at which the cumulative particle volume from the small particle diameter side in the volume-based cumulative particle diameter distribution reaches 90% of the total particle volume.

### TECHNICAL FIELD

The present invention relates to a silicon carbide powder and a production method thereof.

### BACKGROUND ART

A powder of silicon carbide having an α-type crystal form (hereinafter, also referred to as “α-type silicon carbide”) can be produced by pulverizing a raw material containing the α-type silicon carbide into powder, and then classifying the powder according to the particle diameter. For example, PTL 1 discloses a technology of producing the α-type silicon carbide powder by pulverizing a raw material containing the α-type silicon carbide obtained by an Acheson process into powder by a ball mill, and then wet-classifying the powder.

### CITATION LIST

### Patent Literature

PTL 1: JP 2006-83041 A

### SUMMARY OF INVENTION

### Technical Problem

However, in the technology disclosed in PTL 1, it has not been easy to obtain an α-type silicon carbide powder having a small mean particle diameter and a narrow particle diameter distribution width.

It is an object of the present invention to provide the α-type silicon carbide powder having a small mean particle diameter and a narrow particle diameter distribution width. Further, it is an object of the present invention to provide a method for producing a silicon carbide powder capable of obtaining the α-type silicon carbide powder having a small mean particle diameter and a narrow particle diameter distribution width.

### Solution to Problem

A silicon carbide powder according to one aspect of the present invention contains a powder of silicon carbide having an α-type crystal form, in which the mean particle diameter is 300 nm or less, and a ratio D90/D10 between a particle diameter D10 and a particle diameter D90 is 4 or less, the particle diameter D10 being a particle diameter at which the cumulative particle volume from the small particle diameter side in a volume-based cumulative particle diameter distribution reaches 10% of the total particle volume and the particle diameter D90 being a particle diameter at which the cumulative particle volume from the small particle diameter side in the volume-based cumulative particle diameter distribution reaches 90% of the total particle volume.

A method for producing a silicon carbide powder according to another aspect of the present invention is a method for producing the silicon carbide powder according to the above-described one aspect, and includes: a pulverization step of pulverizing a raw material containing silicon carbide having an α-type crystal form into powder; and a classification step of classifying the powder obtained in the pulverization step according to the particle diameter, in which, in the pulverization step, the raw material is pulverized by a bead mill using beads having a diameter of 1 mm or less as media.

### Advantageous Effects of Invention

The silicon carbide powder according to the present invention has a small mean particle diameter and a narrow particle diameter distribution width.

The method for producing a silicon carbide powder according to the present invention enables the production of the silicon carbide powder having a small mean particle diameter and a narrow particle diameter distribution width.

### DESCRIPTION OF EMBODIMENTS

One embodiment of the present invention will now be described in detail. A silicon carbide powder of this embodiment is a powder of silicon carbide (SiC) having an α-type crystal form, in which the mean particle diameter is 300 nm or less (i.e., small mean particle diameter). In the silicon carbide powder of this embodiment, a ratio D90/D10 between a particle diameter D10 and a particle diameter D90 is 4 or less (i.e., narrow particle diameter distribution width), the particle diameter D10 being a particle diameter at which the cumulative particle volume from the small particle diameter side in a volume-based cumulative particle diameter distribution reaches 10% of the total particle volume and the particle diameter D90 being a particle diameter at which the cumulative particle volume from the small particle diameter side in the volume-based cumulative particle diameter distribution reaches 90% of the total particle volume.

The silicon carbide powder of this embodiment has the above-described configuration, and therefore can be suitably used for various applications. For example, the silicon carbide powder can be suitably used as a raw material powder of polishing/grinding materials, electrically conductive materials, thermally conductive materials, ceramic molded products, semiconductor materials, and sintered products.

A method for measuring the mean particle diameters, D10 and D90, of the silicon carbide powder is not particularly limited, and the mean particle diameters can be measured by a laser diffraction method, for example. Examples of a measuring device include a laser diffraction/scattering type particle diameter distribution analyzer LA-960 manufactured by HORIBA.

The silicon carbide powder of this embodiment sometimes contains at least one species of metal among aluminum (Al), iron (Fe), copper (Cu), sodium (Na), titanium (Ti), and chromium (Cr) as impurities. The contents of the metals are preferably as small as possible, and the content is preferably 30 mass ppm or less in any metal. Among the metals above, it is particularly preferable that the contents of iron and copper are small.

When the silicon carbide powder of this embodiment, in which the content of each of the metals is 30 mass ppm or less, is sintered, and the obtained sintered body is used as a semiconductor material, for example, problems are hard to occur in the semiconductor performance of the semiconductor material.

A method for measuring the contents of the metals in the silicon carbide powder is not particularly limited, and the contents of aluminum (Al), iron (Fe), copper (Cu), sodium (Na), titanium (Ti), chromium (Cr), and nickel (Ni) can be measured by an inductively coupled plasma optical emission spectrometry, for example. Examples of a measuring device include an inductively coupled plasma optical emission spectrophotometer ICPS-8100 manufactured by Shimadzu Corporation.

The silicon carbide powder of this embodiment can be produced by the following method. More specifically, a method for producing a silicon carbide powder of this embodiment is a method for producing the silicon carbide powder of this embodiment described above and includes a pulverization step of pulverizing a raw material containing silicon carbide having an α-type crystal form into powder, and a classification step of classifying the powder obtained in the pulverization step according to the particle diameter. Then, in the pulverization step, the raw material is pulverized by a bead mill using beads having a diameter of 1 mm or less as media.

The raw material used in the pulverization step is not particularly limited in the shape and the size insofar as the raw material contains α-type silicon carbide. The shape may be a powdery shape, a granular shape, or a lump shape. For example, an ingot of silicon carbide produced by an Acheson process may be possible. The Acheson process is a method for producing silicon carbide by heating silica rock or a mixture of silica sand and carbon, such as coke, in an Acheson furnace (electric resistance furnace).

The bead mill is a wet-type pulverizer configured to mix bead-like media, a raw material, and a liquid medium and stir the mixture, thereby making the media collide with the raw material and pulverizing the raw material into powder. To obtain the silicon carbide powder having a small mean particle diameter, it is necessary to perform the pulverization using small diameter media. To obtain the silicon carbide powder having a mean particle diameter of 300 nm or less, the diameter of the media needs to be 1 mm or less, preferably 0.5 mm or less, and more preferably 300 μm or less.

The material of the media is not particularly limited and it is preferable to use ceramics, such as alumina, zirconia, and silicon nitride, rather than metals, such as iron. When the ceramic medium is used, impurities, such as metals, are less likely to be mixed into the silicon carbide powder in the pulverization step.

In the classification step, the powder obtained in the pulverization step is classified according to the particle diameter such that the mean particle diameter is 300 nm or less and the ratio D90/D10 is 4 or less. A powder classification method in the classification step is not particularly limited, and a dry-type or wet-type classification method can be adopted. From the viewpoint of the classification accuracy, the classification is preferably performed by a wet type.

In the method for producing a silicon carbide powder of this embodiment, a purification step may be further performed after the classification step. The purification step is a step of bringing the powder obtained in the classification step into contact with a solution having a pH of 10 or more for 1 hour or more, and then bringing the powder into contact with a solution having a pH of 2 or less for 1 hour or more for purification. By carrying out the purification step, the impurities, such as metals, contained in the powder obtained in the classification step are removed, so that the content of the impurities, such as metals, in the silicon carbide powder can be reduced.

A method for bringing the powder obtained in the classification step into contact with the two types of solutions above is not particularly limited. Examples of the method include methods, such as dipping, spraying, and one-way pouring. Examples of the solution having a pH of 10 or more include an aqueous sodium hydroxide solution, an aqueous potassium hydroxide solution, and ammonia water. Examples of the solution having a pH of 2 or less include hydrochloric acid, sulfuric acid, and nitric acid.

It should be noted that this embodiment describes an example of the present invention, and the present invention is not limited to this embodiment. This embodiment can be variously altered or modified, and aspects to which such alternations or modifications are added can also be included in the present invention.

### EXAMPLES

Hereinafter, Examples and Comparative Examples are described, and the present invention is more specifically described.

### Example 1

An ingot containing α-type silicon carbide produced by the Acheson process was pulverized into a powdery state, and the ingot in the powdery state was used as a raw material. The D50 (particle diameter at which the cumulative particle volume from the small particle diameter side in a volume-based cumulative particle diameter distribution reaches 50% of the total particle volume) of the powdery raw material is 5 μm.

Next, the powdery raw material was wet-pulverized by a bead mill using ceramic beads having a diameter of 150 μm as media, thereby obtaining powder (pulverization step). The filling rate of the media to be filled into the bead mill is 80% by volume, and the peripheral speed of the media moving during the pulverization is 10 m/s.

Then, the powder obtained in the pulverization step was classified by elutriation according to the particle diameter (classification step). This classification was performed such that the maximum particle diameter was 1 μm or less.

Further, the powder obtained in the classification step was dipped in a solution having a pH of 10 or more for 1 hour or more, and then dipped in a solution having a pH of 2 or less for 1 hour or more for purification, so that impurities, such as metals, were removed (purification step).

The D10, D50 (mean particle diameter), and D90 of the α-type silicon carbide powder thus obtained were measured using a laser diffraction/scattering type particle diameter distribution analyzer LA-960 manufactured by HORIBA. Then, the ratio D90/D10 was calculated from the measured D10 and D90. The results are shown in Table 1.

The contents of various metals in the α-type silicon carbide powder thus obtained were measured using an inductively coupled plasma optical emission spectrophotometer ICPS-8100 manufactured by Shimadzu Corporation. The results are shown in Table 1.

TABLE 1

| | | Ex. 1 | Ex. 2 | Ex. 3 |
|---|---|---|---|---|
| Particle diameter | D10 (μm) | 67 | 133 | 111 |
| | D50 (μm) | 88 | 245 | 350 |
| | D90 (μm) | 126 | 477 | 750 |
| | D90/D10 | 1.88 | 3.59 | 6.76 |
| Metal (ppm) | Na | 1 | 22 | 571 |
| | Al | 4 | 9 | 986 |
| | Ti | 23 | 25 | 63 |
| | Cr | 9 | 4 | 59 |
| | Fe | 6 | 13 | 465 |
| | Ni | 3 | 1 | 7 |
| | Cu | 2 | 0.5 | 5 |
| | Mg | 0.3 | 4 | 7 |
| | K | 4 | 4 | 8 |
| | Ca | 5 | 30 | 13 |

### Example 2

An ingot containing α-type silicon carbide produced by the Acheson process was pulverized into a powdery state, and the powdery was used as a raw material. The D50 of the powdery raw material is 5 μm.

Next, the powdery raw material was wet-pulverized by a bead mill using ceramic beads having a diameter of 300 μm as media, thereby obtaining powder. The filling rate of the media to be filled into the bead mill is 80% by volume, and the peripheral speed of the media moving during the pulverization is 12 m/s.

Then, the powder obtained in the pulverization step was classified by elutriation according to the particle diameter. This classification was performed such that the maximum particle diameter was 2 μm or less.

Further, the powder obtained in the classification step was dipped in a solution having a pH of 10 or more for 1 hour or more, and then dipped in a solution having a pH of 2 or less for 1 hour or more for purification, thereby removing impurities, such as metals.

The D10, D50 (mean particle diameter), and D90 of the α-type silicon carbide powder thus obtained were measured using a laser diffraction/scattering type particle diameter distribution analyzer LA-960 manufactured by HORIBA. Then, the ratio D90/D10 was calculated from the measured D10 and D90. The results are shown in Table 1.

The contents of various metals in the α-type silicon carbide powder thus obtained were measured using an inductively coupled plasma optical emission spectrophotometer ICPS-8100 manufactured by Shimadzu Corporation. The results are shown in Table 1.

### Comparative Example 1

An ingot containing α-type silicon carbide produced by the Acheson process was pulverized into a powdery state, and the ingot in the powdery state was used as a raw material. The D50 of the powdery raw material is 20 μm.

Next, the powdery raw material was wet-pulverized by a ball mill using iron balls having a diameter of 10 to 20 mm as media, thereby obtaining powder.

Then, the powder obtained in the pulverization step was classified by elutriation according to the particle diameter. This classification was performed such that the maximum particle diameter was 5 μm or less. The following purification step was not performed.

The D10, D50 (mean particle diameter), and D90 of the α-type silicon carbide powder thus obtained were measured using a laser diffraction/scattering type particle diameter distribution analyzer LA-960 manufactured by HORIBA. Then, the ratio D90/D10 was calculated from the measured D10 and D90. The results are shown in Table 1.

The contents of various metals in the α-type silicon carbide powder thus obtained were measured using an inductively coupled plasma optical emission spectrophotometer ICPS-8100 manufactured by Shimadzu Corporation. The results are shown in Table 1.

As is understood from Table 1, the α-type silicon carbide powders of Examples 1, 2 had the D50 (mean particle diameter) of 300 nm or less and the ratio D90/D10 of 4 or less. More specifically, the mean particle diameters of the α-type silicon carbide powders were small and the particle diameter distribution widths thereof were narrow. In contrast thereto, the α-type silicon carbide powder of Comparative Example 1 had the D50 (mean particle diameter) of more than 300 nm and the ratio D90/D10 of more than 4.

1. A silicon carbide powder, comprising:
a powder of silicon carbide having an α-type crystal form, wherein
a mean particle diameter is 300 nm or less, and
a ratio D90/D10 between a particle diameter D10 and a particle diameter D90 is 4 or less, the particle diameter D10 being a particle diameter at which a cumulative particle volume from a small particle diameter side in a volume-based cumulative particle diameter distribution reaches 10% of a total particle volume and the particle diameter D90 being a particle diameter at which the cumulative particle volume from the small particle diameter side in the volume-based cumulative particle diameter distribution reaches 90% of the total particle volume.

2. The silicon carbide powder according to claim 1, comprising at least one species of metal among aluminum, iron, copper, sodium, titanium, chromium, nickel, magnesium, potassium, and calcium as impurities, wherein
a content of each of the metals is 30 mass ppm or less.

3. A method for producing a silicon carbide powder, the silicon carbide powder being the silicon carbide according to claim 1 or 2,
the method comprising:
a pulverization step of pulverizing a raw material containing silicon carbide having an α-type crystal form into powder; and
a classification step of classifying the powder obtained in the pulverization step according to a particle diameter, wherein
in the pulverization step, the raw material is pulverized by a bead mill using beads having a diameter of 1 mm or less as media.

4. The method for producing a silicon carbide powder according to claim 3 further comprising:
a purification step of bringing the powder obtained in the classification step into contact with a solution having a pH of 10 or more for 1 hour or more, and then bringing the powder into contact with a solution having a pH of 2 or less for 1 hour or more for purification.

5. A method for producing a silicon carbide powder, the silicon carbide powder being the silicon carbide according to claim 2,
the method comprising:
a pulverization step of pulverizing a raw material containing silicon carbide having an α-type crystal form into powder; and
a classification step of classifying the powder obtained in the pulverization step according to a particle diameter, wherein
in the pulverization step, the raw material is pulverized by a bead mill using beads having a diameter of 1 mm or less as media.
